(19) United States
(12) Patent Application Publication
(10) Pub. No.: US 2017/0199867 A1
(43) Pub. Date: Jul. 13, 2017

(54) DIALOGUE CONTROL SYSTEM AND DIALOGUE CONTROL METHOD

(71) Applicant: Mitsubishi Electric Corporation, Tokyo (JP)

(72) Inventors: Yusuke KOJI, Tokyo (JP); Yoichi FUJII, Tokyo (JP); Jun ISHII, Tokyo (JP)

(73) Assignee: Mitsubishi Electric Corporation, Tokyo (JP)

(21) Appl. No.: 15/314,834

(22) PCT Filed: Oct. 30, 2014
(86) PCT No.: PCT/JP2014/078947

§ 371 Date: Nov. 29, 2016

(51) Int. Cl. G06F 17/27

(52) U.S. Cl. CPC G06F 17/279; G06F 17/2755; G06F 17/277; G06F 17/271

(57) ABSTRACT

A configuration includes: a morphological analyzer configured to analyze a text provided as an input in a form of natural language by a user; an intention-estimation processor configured to refer to an intention estimation model in which words and corresponding user's intentions to be estimated from the words are stored, to thereby estimate an intention of the user based on the text analysis results obtained by the morphological analyzer; an unknown-word extractor configured to extract, as an unknown word, a word that is not stored in the intention estimation model from among the text analysis results when the intention of the user fails to be uniquely determined by the intention estimation processor; and a response text message generator configured to generate a response text message that includes the unknown word extracted by the unknown-word extractor.

### TECHNICAL FIELD

The present invention relates to a dialogue control system and dialogue control method for recognizing a text provided as an input such as a voice input or a keyboard input by a user, for example, and for estimating an intention of the user on the basis of the result of the recognition to thereby conduct a dialogue for execution of an operation intended by the user.

### BACKGROUND ART

In recent years, in order to execute an operation of an apparatus, speech recognition systems have been used to receive a voice input produced by a person, for example, and to execute an operation using the result of recognition of the voice input. In such speech recognition systems, heretofore, possible speech recognition results expected by the system and corresponding operations are associated in advance with each other. When a speech recognition result is matched with the expected one, its corresponding operation is executed. Thus, to execute an operation, the user needs to learn the expressions in advance which are expected by the system.

As a technique for making the speech recognition system operable according to unrestricted speech even if the user does not learn the expressions for accomplishing his/her purpose, a method in which a device estimates an intention of user's speech to conduct a dialogue to thereby accomplish a purpose is disclosed. According to this method, in order to support a wide variety of spoken expressions produced by the user, it is required to use a wide variety of sentence examples for the learning for a speech recognition dictionary, and also to use a wide variety of sentence examples for the learning for an intention estimation dictionary that is used in intention estimation techniques for estimating the intention of the speech.

However, although it is relatively easy to increase the sentence examples because language models to be used in the speech recognition dictionary are automatically collectable, there is the problem that it is takes a lot of effort to prepare learning data for the intention estimation dictionary in comparison with that for the speech recognition dictionary because correct answers in preparing learning data for the intention estimation dictionary need to be manually provided. Also, because the user speaks using new words or slang words in some cases, the number of words increases as time goes by. There is the problem that it is costly to design the intention estimation dictionary suitable for such a wide variety of words.

To address the above problems, Patent Literature 1 as an example discloses a voice-input processing apparatus that uses a synonym dictionary for increasing acceptable words for each sentence example. By using the synonym dictionary, if accurate results of a speech recognition are obtained, the words of the accurate results of the speech recognition, which correspond to those contained in the synonym dictionary, can be replaced by representative words. This enables an intention estimation dictionary suitable for such a wide variety of words to be obtained even if learning is performed by only sentence examples using representative words.

### CITATION LIST

### Patent Literature

Patent Literature 1: Japanese Patent Application Publication No. 2014-106523.

### SUMMARY OF INVENTION

### Technical Problem

However, according to the technique in Patent Literature 1 described above, the updating of the synonym dictionary requires manual checking, and it is not easy to respond to all kinds of words. Thus, there is the problem that it possibly occurs that the estimation of the user's intention fails if the user uses a word that is absent in the synonym dictionary. In addition, if the user's intention fails to be accurately estimated, a response of the system is not matched with the user's intention. Then, because the system does not provide feedback to the user on the reason why the response is not matched with the user's intention, there is the problem that the user cannot understand the reason and continues to use the words absent in the synonym dictionary, thereby failing to conduct a dialogue or conducting a wordy dialogue.

The invention has been made to solve the problems as described above, and an object of the invention is to, when the user uses a word that is unrecognizable in a dialogue control system, provide feedback to the user on the information indicating that the unrecognizable word cannot be used, and to provide the user with a response that enables the user to recognize how the user should input again.

### Solution to Problem

According to the invention, there is provided a dialogue control system which includes: a text analyzing unit configured to analyze a text provided as an input in a form of natural language by a user; an intention-estimation processor configured to refer to an intention estimation model in which words and corresponding user's intentions to be estimated from the words are stored, to thereby estimate an intention of the user based on text analysis results obtained by the text analyzing unit; an unknown-word extracting unit configured to extract, as an unknown word, a word that is not stored in the intention estimation model from among the text analysis results when the intention of the user fails to be uniquely determined by the intention estimation processor; and a response text message generating unit configured to generate a response text message that includes the unknown word extracted by the unknown-word extracting unit.

### Advantageous Effects of Invention

According to the invention, the user can easily recognize what expression the user should input again correctly, thus being able to conduct a smooth dialogue with the dialogue control system.

### BRIEF DESCRIPTION OF DRAWINGS

FIG. 1 is a block diagram showing a configuration of a dialogue control system according to a first embodiment.

FIG. 2 is a diagram showing an example of a dialogue between a user and the dialogue control system according to the first embodiment.

FIG. 3 is a flowchart showing operations of the dialogue control system according to the first embodiment.

FIG. 4 is a diagram showing an example of a feature list that is morphological analysis results obtained by a morphological analyzer in the dialogue control system according to the first embodiment.

FIG. 5 is a diagram showing an example of intention estimation results obtained by an intension-estimation processor in the dialogue control system according to the first embodiment.

FIG. 6 is a flowchart showing operations of an unknown-word extractor in the dialogue control system according to the first embodiment.

FIG. 7 is a diagram showing an example of a list of unknown-word candidates extracted by the unknown-word extractor in the dialogue control system according to the first embodiment.

FIG. 8 is a diagram showing an example of dialogue-scenario data stored in a dialogue-scenario data storage in the dialogue control system according to the first embodiment.

FIG. 9 is a block diagram showing a configuration of an dialogue control system according to a second embodiment.

FIG. 10 is a diagram showing an example of a frequently-appearing word list stored in an intention estimation-model storage in the dialogue control system according to the second embodiment.

FIG. 11 is a diagram showing an example of a dialogue between a user and the dialogue control system according to the second embodiment.

FIG. 12 is a flowchart showing operations of the dialogue control system according to the second embodiment.

FIG. 13 is a flowchart showing operations of an unknown-word extractor in the dialogue control system according to the second embodiment.

FIG. 14 is a diagram showing an example of the syntactic analysis result obtained by a syntactic analyzer in the dialogue control system according to the second embodiment.

FIG. 15 is a block diagram showing a configuration of a dialogue control system according to a third embodiment.

FIG. 16 is a diagram showing an example of a dialogue between a user and the dialogue control system according to the third embodiment.

FIG. 17 is a flowchart showing operations of the dialogue control system according to the third embodiment.

FIG. 18 is a diagram showing an example of intention estimation results obtained by an intension estimation processor in the dialogue control system according to the third embodiment.

FIG. 19 is a flowchart showing operations of a known-word extraction processor in the dialogue control system according to the third embodiment.

FIG. 20 is a diagram showing an example of dialogue-scenario data stored in a dialogue-scenario data storage in the dialogue control system according to the third embodiment.

### DESCRIPTION OF EMBODIMENTS

Hereinafter, for describing the invention in more detail, embodiments for carrying out the invention will be described with reference to the accompanying drawings.

### First Embodiment

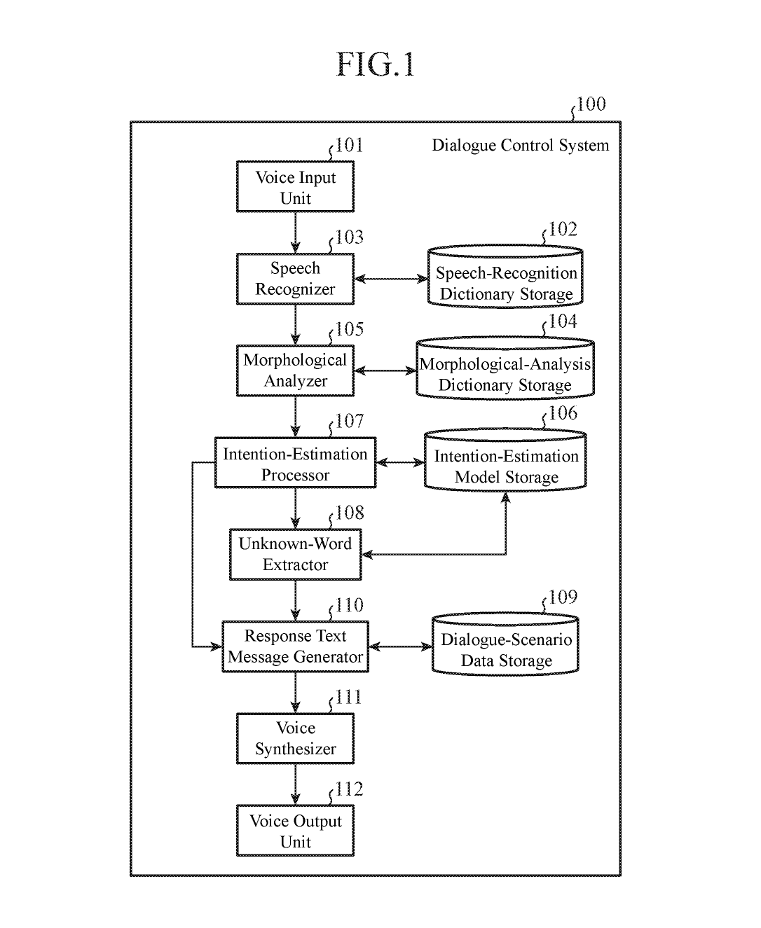

FIG. 1 is a configuration diagram showing a dialogue control system 100 according to a first embodiment.

The dialogue control system 100 of the first embodiment includes: a voice input unit 101, a speech-recognition dictionary storage 102, a speech recognizer 103, a morphological-analysis dictionary storage 104, a morphological analyzer (a text analyzing unit) 105, an intention-estimation model storage 106, an intention-estimation processor 107, an unknown-word extractor 108, a dialogue-scenario data storage 109, a response text message generator 110, a voice synthesizer 111 and a voice output unit 112.

Hereinafter, descriptions will be made using, as an example, the case where the dialogue control system 100 is applied to a car-navigation system. It should be noted that the applicable scope is not limited to the car-navigation system and may be changed appropriately. Further, descriptions will be made using, as an example, the case where the user conducts a dialogue with the dialogue control system 100 by providing a voice input thereto. It should be noted that means for conducting a dialogue with the dialogue control system 100 is not limited to the voice input.

The voice input unit 101 receives a voice input that is fed to the dialogue control system 100. The speech-recognition dictionary storage 102 is a region where a speech recognition dictionary used for performing speech recognition is stored. With reference to the speech recognition dictionary stored in the speech-recognition dictionary storage 102, the speech recognizer 103 performs speech recognition of the voice data that is fed to the voice input unit 101, to thereby convert it into a text. The morphological-analysis dictionary storage 104 is a region where a morphological analysis dictionary used for performing morphological analysis is stored. The morphological analyzer 105 divides the text obtained by the speech recognition into morphemes. The intention-estimation model storage 106 is a region where an intention estimation model used for estimating a user's intention (hereinafter, referred to as the intention) on the basis of the morphemes is stored. The intention-estimation processor 107 receives the morphological analysis results as an input obtained by the morphological analyzer 105, and estimates the intention with reference to the intention estimation model. The result of the estimation is outputted as a list representing pairs of estimated intentions and their respective scores indicative of likelihoods of these intentions.

Next, the details of the intention-estimation processor 107 will be described.

The intention estimated by the intention-estimation processor 107 is represented, for example, in such a form of “<main intention>[{<slot name>=<slot value>}, . . . ]”. For example, it may be represented as “Setting of Destination Point [{Facility=<Facility Name>}]” or “Route Change [{Criterion=Ordinary Road With High-Priority}]”. With respect to “Destination Point Setting [{Facility=<Facility Name>}]”, a specific facility name is put in <Facility Name>. For example, in the case of <Facility Name>=“Tokyo Skytree”, the intention that the user wants to set “Tokyo Skytree” as a destination point is indicated, and in the case of “Route Change [{Criterion=Ordinary Road With High-Priority}]”, the intention that the user wants to set “Ordinary Road With High-Priority” as the route search criterion is indicated.

Further, when the slot value is “NULL”, the intention with uncertain slot value is indicated. For example, the intention represented as “Route Change [{Criterion=NULL}]” indicates the intention that the user wants to set the route search criterion but the criterion is yet uncertain.

In an intention estimation method performed by the intention estimation processor 107, a method such as, for example, a maximum entropy method or the like, is applicable. Specifically, with respect to the speech of “Change the route to be an ordinary road with high-priority”, content words of “route, ordinary Road, preference, change” (hereinafter, each referred to as a feature) extracted from the morphological analysis results, and corresponding correct intentions of “Route Change [{Criterion=Ordinary Road With High-Priority}]”, are provided as sets. A large number of sets of features and corresponding intentions are collected, and then, it is estimated that each of the intentions has how much likelihood for a list of the features, using a statistical method. In the following, descriptions will be made assuming that the intention estimation utilizing the maximum entropy method is performed.

The unknown-word extractor 108 extracts from among the features extracted by the morphological analyzer 105, a feature that is not stored in the intention estimation model of the intention-estimation model storage 106. Hereinafter, the feature not included in the intention estimation model is referred to as an unknown word. The dialogue-scenario data storage 109 is a region where dialogue-scenario data containing information as to what is to be executed subsequently in response to the intention estimated by the intention-estimation processor 107, is stored. The response text message generator 110 uses as inputs the intentions estimated by the intention-estimation processor 107 and the unknown word if the unknown word is extracted by the unknown-word extractor 108, to thereby generate a response text message using the dialogue-scenario data stored in the dialogue-scenario data storage 109. The voice synthesizer 111 uses as an input the response text message generated by the response text message generator 110 to thereby generate a synthesized voice. The voice output unit 112 outputs the synthesized voice generated by the voice synthesizer 111.

Next, description will be made about the operations of the dialogue control system 100 according to the first embodiment.

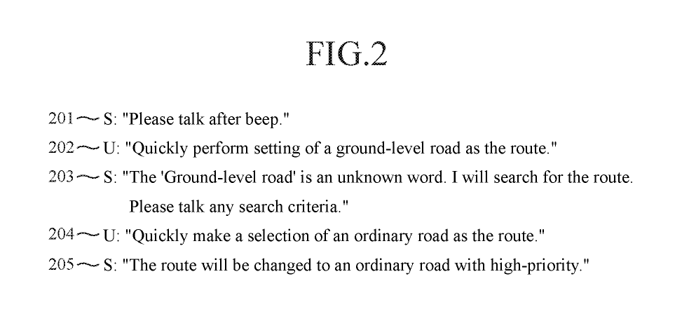

FIG. 2 is a diagram showing an example of a dialogue between the user and the dialogue control system 100 according to the first embodiment.

First, at beginning of each line, “U:” represents a user's speech, and “S:” represents a response from the dialogue control system 100. A response 201, a response 203 and a response 205 are each an output from the dialogue control system 100, and a speech 202 and a speech 204 are each a user's speech, and there is thus shown that dialogue proceeds sequentially.

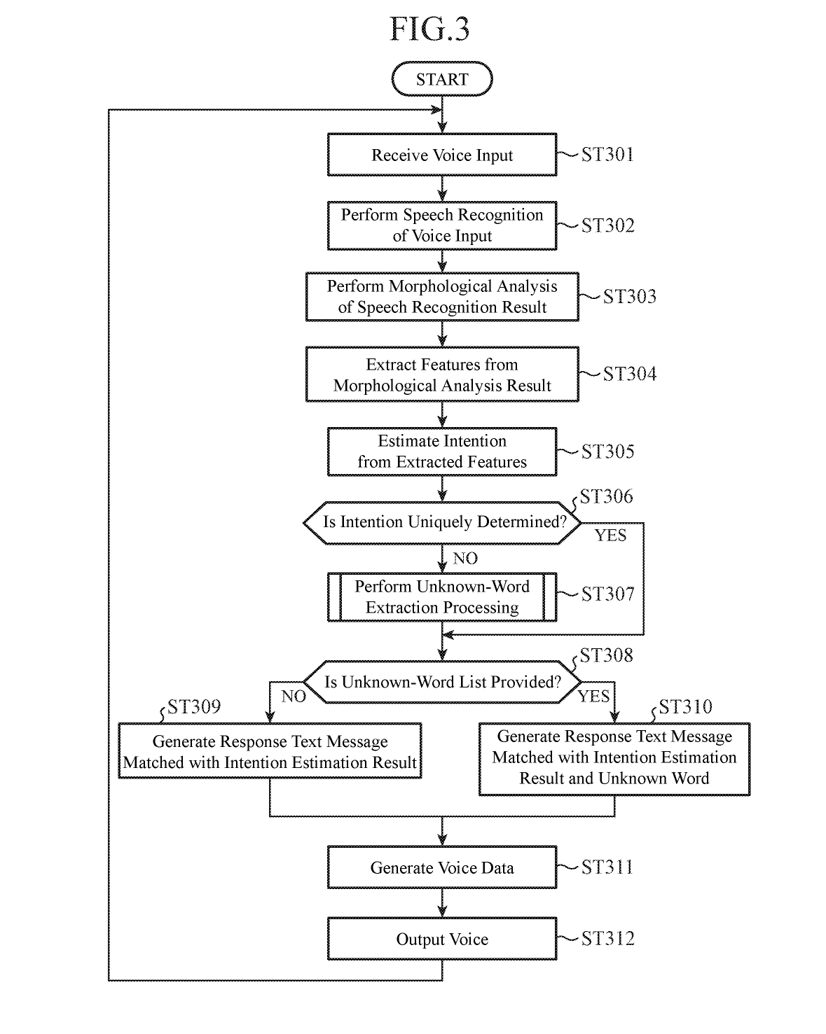

Based on the dialogue example in FIG. 2, processing operations to be performed by the dialogue control system 100 for generating the response text message will be described with reference to FIGS. 3 to 8.

FIG. 3 is a flowchart showing operations of the dialogue control system 100 according to the first embodiment.

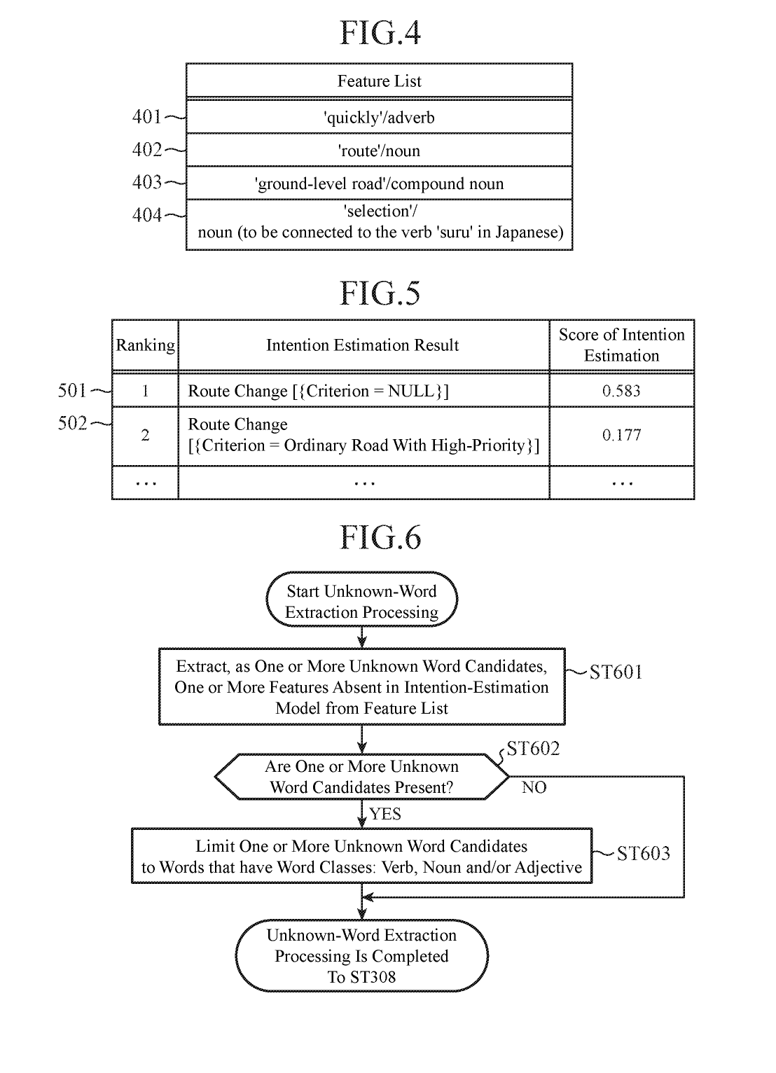

FIG. 4 is a diagram showing an example of a feature list that is morphological analysis results obtained by the morphological analyzer 105 in the dialogue control system 100 according to the first embodiment. In the example in FIG. 4, the list consists of a feature 401 to a feature 404.

FIG. 5 is a diagram showing an example of intention estimation results obtained by the intension-estimation processor 107 in the dialogue control system 100 according to the first embodiment. As an intention estimation result 501, an intention estimation result having the first ranked intention estimation score is shown with that intention estimation score, and as an intention estimation result 502, an intention estimation result having the second ranked intention estimation score is shown with that intention estimation score.

FIG. 6 is a flowchart showing operations of the unknown-word extractor 108 in the dialogue control system 100 according to the first embodiment.

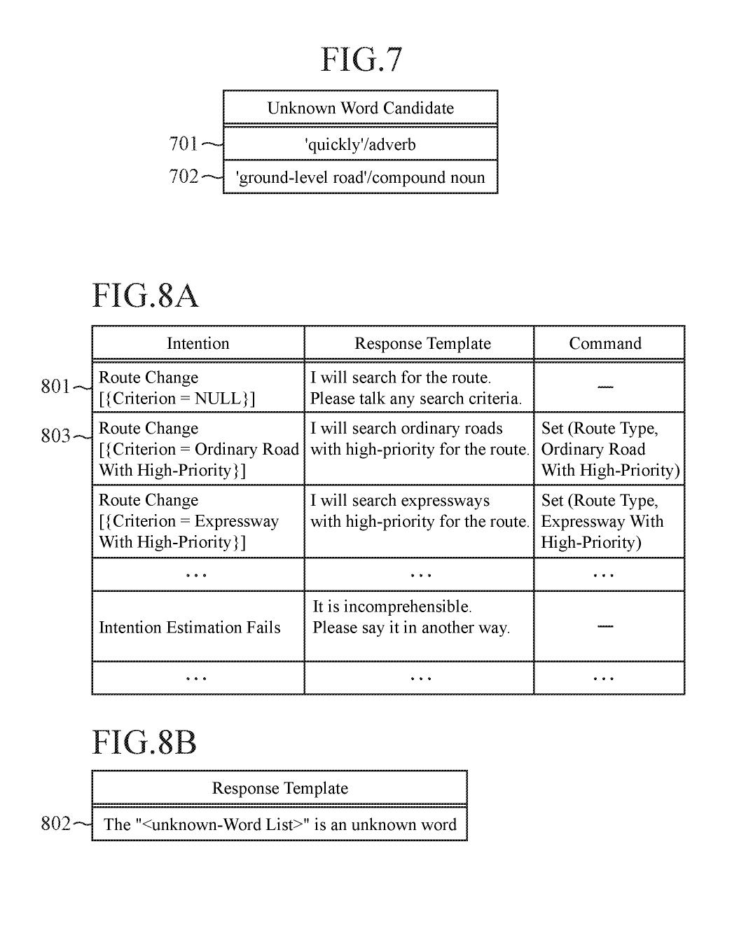

FIG. 7 is a diagram showing an example of a list of unknown-word candidates extracted by the unknown-word extractor 108 in the dialogue control system 100 according to the first embodiment. In the example in FIG. 7, the list consists of an unknown-word candidate 701 and an unknown-word candidate 702.

FIG. 8 is a diagram showing an example of dialogue-scenario data stored in the dialogue-scenario data storage 109 in the dialogue control system 100 according to the first embodiment. In the dialogue-scenario data for intention in FIG. 8A, responses to be provided by the dialogue control system 100 for the respective intention estimation results are included, and commands to be executed by the dialogue control system 100 for a device (not shown) controlled by that system are included. Further, in the dialogue-scenario data for unknown word in FIG. 8B, a response to be provided by the dialogue control system 100 for the unknown word is included.

First, description will be made according to the flowchart in FIG. 3. When the user presses a dialogue start button (not shown) or the like, that is provided in the dialogue control system 100, the dialogue control system 100 outputs a response and a beep sound for prompting starting of dialogue. In the example in FIG. 2, when the user presses the dialogue start button, the dialogue control system 100 outputs by voice the response 201 of “Please talk after beep” and then outputs a beep sound. After they are outputted, the voice recognizer 103 becomes in a recognizable state and the procedure moves to the processing in Step ST301 in the flowchart in FIG. 3. Note that the beep sound after the voice outputting may be changed appropriately.

The voice input unit 101 receives a voice input (Step ST301). In the example in FIG. 2, because the user would like to search for the route using an ordinary road with high-priority as the search criterion, the user speaks to make the speech 202 of “Quickly perform setting of a ground-level road as the route” [“Sakutto, ‘route’ wo shita-michi ni settei si te” in Japanese pronunciation], and in that case, the voice input unit 101 receives that speech as a voice input in Step ST301. The speech recognizer 103 refers to the speech recognition dictionary stored in the speech-recognition dictionary storage 102, to thereby perform speech recognition of the voice input received in Step ST301 to convert it into a text (Step ST302).

The morphological analyzer 105 refers to the morphological analysis dictionary stored in the morphological-analysis dictionary storage 104, to thereby perform morphological analysis of the speech recognition result converted into the text in Step ST302 (Step ST303). In the example in FIG. 2, with respect to the speech recognition result of “Quickly perform setting of a ground-level road as the route” [“Sakutto, ‘route’ wo shita-michi ni settei si te” in Japanese pronunciation] for the speech 202, the morphological analyzer 105 performs morphological analysis in Step ST303 so as to obtain “‘quickly’ [Sakutto]/adverb; ‘route’/noun; [wo]/postpositional particle; ‘ground-level road’ [shita-michi]/noun; [ni]/post-positional particle; ‘setting’ [settei]/noun (to be connected to the verb ‘suru’ in Japanese pronunciation); ‘perform’[si]/verb; and [te]/postpositional particle”.

Next, the intention-estimation processor 107 extracts from the morphological analysis results obtained in Step ST303, the features to be used in intention estimation processing (Step ST304), and performs the intention estimation processing for estimating an intention from the features extracted in Step ST304, using the intention estimation model stored in the intention-estimation model storage 106 (Step ST305).

According to the example in FIG. 2, with respect to the morphological analysis results: “‘quickly’ [Sakutto]/adverb; ‘route’/noun; [wo]/postpositional particle; ‘ground-level road’ [shita-michi]/noun; [ni]/post-positional particle; ‘setting’ [settei]/noun (to be connected to the verb ‘suru’ in Japanese pronunciation); ‘perform’[si]/verb; and [te]/postpositional particle”, the intention-estimation processor 107 extracts the features therefrom in Step ST304 to thereby collect them as a feature list as shown in FIG. 4 as an example. The feature list in FIG. 4 consists of: the feature 401 of “‘quickly’/adverb”; the feature 402 of “‘route’/noun”; the feature 403 of “‘ground-level road’/noun”; and the feature 404 of “‘setting’/noun (to be connected to the verb ‘suru’ in Japanese pronunciation)”.

With respect to the feature list shown in FIG. 4, the intention-estimation processor 107 performs intention estimation processing in Step ST305. If the features of “‘quickly’/adverb” and “‘ground-level road’/noun” are absent in the intention estimation model, for example, the intention estimation processing is executed based on the features of “‘route’/noun” and “‘setting’/noun (to be connected to the verb ‘suru’ in Japanese pronunciation), so that the intention-estimation result list shown in FIG. 5 is obtained. The intention-estimation result list is comprised of rankings, intention estimation results and intention estimation scores, in which it is shown that the intention estimation result of “Route Change [{Criterion=NULL}]” indicated with the ranking “1” has an intention estimation score of 0.583. Further, it is shown that the intention estimation result of “Route Change [{Criterion=Ordinary Road With High-Priority}]” indicated with the ranking “2” has an intention estimation score of 0.177. Note that, in FIG. 5, intention estimation results and their intention estimation scores with the rankings subsequent to the ranking “1” and the ranking “2” are omitted from illustration, but may be set as well.

The intention-estimation processor 107 judges based on the intention-estimation result list obtained in Step ST305, whether or not an intention of the user can be uniquely determined (Step ST306). In the judgement processing in Step ST306, when, for example, the following two criteria (a), (b) are both satisfied, it is judged that an intention of the user can be uniquely determined.

Criterion (a): an intention estimation score of the first ranked intention estimation result is 0.5 or more.

Criterion (b): a slot value of the first ranked intention estimation result is not “NULL”.

When the criterion (a) and the criterion (b) are both satisfied, namely, when an intention of the user can be uniquely determined (Step ST306; YES), the procedure moves to the processing in Step ST308. On this occasion, the intention-estimation processor 107 outputs the intention-estimation result list to the response text message generator 110.

In contrast, when at least one of the criterion (a) and the criterion (b) is not satisfied, namely, when no intention of the user can be uniquely determined (Step ST306; NO), the procedure moves to the processing in Step ST307. On this occasion, the intention-estimation processor 107 outputs the intention-estimation result list and the feature list to the unknown-word extractor 108.

In the case of the intention estimation results shown in FIG. 5, the intention estimation score with the ranking “1” is “0.583” and thus satisfies the criterion (a), but the slot value is “NULL” and thus does not satisfy the criterion (b). Accordingly, in the judgement processing in Step ST306, the intention-estimation processor 107 judges that no intention of the user can be determined, and then, the procedure moves to the processing in Step ST307.

In Step ST307, the unknown-word extractor 108 performs unknown-word extraction processing, on the basis of the feature list provided from the intention-estimation processor 107. The unknown-word extraction processing in Step ST307 will be described in detail with reference to the flowchart in FIG. 6.

The unknown-word extractor 108 extracts from the provided feature list, any feature that is not included in the intention estimation model stored in the intention-estimation model storage 106, as an unknown-word candidate, and adds it to an unknown-word candidate list (Step ST601).

In the case of the feature list shown in FIG. 4, the feature 401 of “‘quickly’/adverb” and the feature 403 of “‘ground-level road’/noun” are extracted as unknown word candidates and added to the unknown-word candidate list shown in FIG. 7.

Then, the unknown-word extractor 108 judges whether or not one or more unknown-word candidates have been extracted in Step ST601 (Step ST602). When no unknown-word candidate has been extracted (Step ST602; NO), the unknown-word extraction processing is terminated and the procedure moves to the processing in Step ST308. On this occasion, the unknown-word extractor 108 outputs the intention-estimation result list to the response text message generator 110.

In contrast, when one or more unknown-word candidates have been extracted (Step ST602; YES), the unknown-word extractor 108 deletes from the unknown-word candidates included in the unknown-word candidate list, any unknown-word candidate whose lexical category is other than verb, noun and adjective, to thereby modify the list into an unknown-word list (Step ST603), and then the procedure moves to the processing in Step ST308. On this occasion, the unknown-word extractor 108 outputs the intention-estimation result list and the unknown-word list to the response text message generator 110.

In the case of the unknown-word candidate list shown in FIG. 7, since the number of the unknown-word candidates is two, it is determined to be “YES” in Step ST602, so that the procedure moves to the processing in Step ST603. In that Step ST603, the unknown-word candidate 701 of “‘quickly’/adverb” whose lexical category is adverb is deleted, so that only the unknown-word candidate 702 of “‘ground-level road’/noun” remains in the unknown-word list.

Returning to the flowchart in FIG. 3, descriptions will be continued about the operations.

The response text message generator 110 judges whether or not the unknown-word list has been provided by the unknown-word extractor 108 (Step ST308). When no unknown-word list has been provided (Step ST308; NO), the response text message generator 110 generates a response text message using the dialogue-scenario data stored in the dialogue-scenario data storage 109 by reading out therefrom a response template matched with the intention estimation result (Step ST309). Further, when a corresponding command is set in the dialogue-scenario data, the command will be executed according to Step ST309.

When the unknown-word list has been provided (Step ST308; YES), the response text message generator 110 generates a response text message using the dialogue-scenario data stored in the dialogue-scenario data storage 109 by reading out therefrom a response template matched with the intention estimation result and a response template matched with the unknown word indicated by the unknown-word list (Step ST310). At the generation of the response text message, a response text message matched with the unknown-word list is inserted before a response text message matched with the intention estimation result. Further, when a corresponding command is set in the dialogue-scenario data, the command will be executed according to Step ST310.

In the case described above, because the unknown-word list in which the unknown word of “‘ground-level road’/noun” is included is generated in Step ST603, the response text message generator 110 judges in Step ST308 that the unknown-word list has been provided, and generates the response text message matched with the intention estimation result and the unknown word in Step ST310. Specifically, in the case of the intention-estimation result list shown in FIG. 5, as a response template matched with the first ranked intention estimation result of “Route Change [{Criterion=NULL}]”, a template 801 in the dialogue-scenario data for intention in FIG. 8A is read out, so that a response text message of “I will search for the route. Please talk any search criteria” is generated. Then, the response text message generator 110 replaces <Unknown Word> in a template 802 in the dialogue-scenario data for unknown word shown in FIG. 8B, with an actual value in the unknown-word list, to thereby generate a response text message. In the case described above, the provided unknown word is “ground-level road”, so that the generated response text message is “The word ‘Ground-level road’ is an unknown word”. Lastly, this response text message matched with the unknown-word list is inserted before the response text message matched with the intention estimation result, so that the response text message “The word ‘Ground-level road’ is an unknown word. I will search for the route. Please talk any search criteria” is generated.

The voice synthesizer 111 generates voice data from the response text message generated in Step ST309 or Step ST310, and provides the voice data to the voice output unit 112 (Step ST311). The voice output unit 112 outputs as voice, the provided voice data in Step ST311 (Step ST312). Consequently, processing of generating the response text message with respect to one user's speech is completed. Thereafter, the procedure in the flowchart returns to the processing in Step ST301, to wait a voice input to be made by the user.

In the case described above, the response 203 of “The word ‘Ground-level road’ is an unknown word. I will search for the route. Please talk any search criteria” as shown in FIG. 2 is outputted by voice.

Because the response 203 is outputted by voice, the user can be aware that he/she just has to make a speech using an expression different to “ground-level road”. For example, the user can talk again in a manner represented by the speech 204 of “Quickly perform setting of an ordinary road as the route” in FIG. 2, to thereby carry forward the dialogue with the dialogue control system 100.

When the user makes the speech 204 described above, the dialogue control system 100 executes again the speech recognition processing shown in the flowcharts in FIG. 3 and FIG. 6, on that speech 204. As the result, the feature list obtained in Step ST304 consists of the extracted four features of “‘quickly’/adverb”, “‘route’/noun”, “‘ordinary road’/noun” and “‘setting’/noun (to be connected to the verb ‘suru’ in Japanese pronunciation)”. In this feature list, the unknown word is “‘quickly’/adverb” only. Then, in Step ST305, an intention estimation result of “[{Criterion=Ordinary Road With High-Priority}]” with the ranking “1” is obtained with an intention estimation score of “0.822”.

Then, in the judgement processing in Step ST306, because the intention estimation score of the intention estimation result with the ranking “1” is “0.822” and thus satisfies the criterion (a), and the slot value is not “NULL” and thus satisfies the criterion (b), it is judged that an intention of the user can be uniquely determined, so that the procedure moves to the processing in Step ST308. In Step ST308, it is judged that no unknown-word list has been provided, and then, in Step ST309, a template 803 in the dialogue-scenario data for intention in FIG. 8A is read out as the response template matched with “Route Change [{Criterion=Ordinary Road With High-Priority}]”, so that the response text message “I will search for an ordinary road with high-priority as the route” is generated, and a command of “Set (Route Type, Ordinary Road With High-Priority)” that is for searching for the route while giving an ordinary road with high-priority, is executed. Then, in Step ST311, voice data is generated from the response text message, and in Step ST312, the voice data is outputted by voice. In this manner, it is possible to execute the command according to the original intention of the user of “I want to search for the route with the search criterion of giving an ordinary road with high-priority”, through a smooth dialogue with the dialogue control system 100.

As described above, the configuration according to the first embodiment includes: the morphological analyzer 105 that divides the speech recognition result into morphemes; the intention-estimation processor 107 that estimates an intention of the user from the morphological analysis results; the unknown-word extractor 108 that, when an intention of the user fails to be uniquely determined by the intention-estimation processor 107, extracts a feature that is absent in the intention estimation model, as an unknown word; and the response text message generator 110 that, when the unknown word is extracted, generates a response text message including the unknown word. Thus, it is possible to generate the response text message including a word extracted as the unknown word, to thereby present to the user, the word from which any intention fails to be estimated by the dialogue control system 100. This makes it possible for the user to recognize the word to be changed in expression, so that the dialogue can proceed smoothly.

### Second Embodiment

In a second embodiment, descriptions will be made about a configuration for further analyzing syntactically the morphological analysis results, to thereby perform extraction of unknown word using the syntactic analysis result.

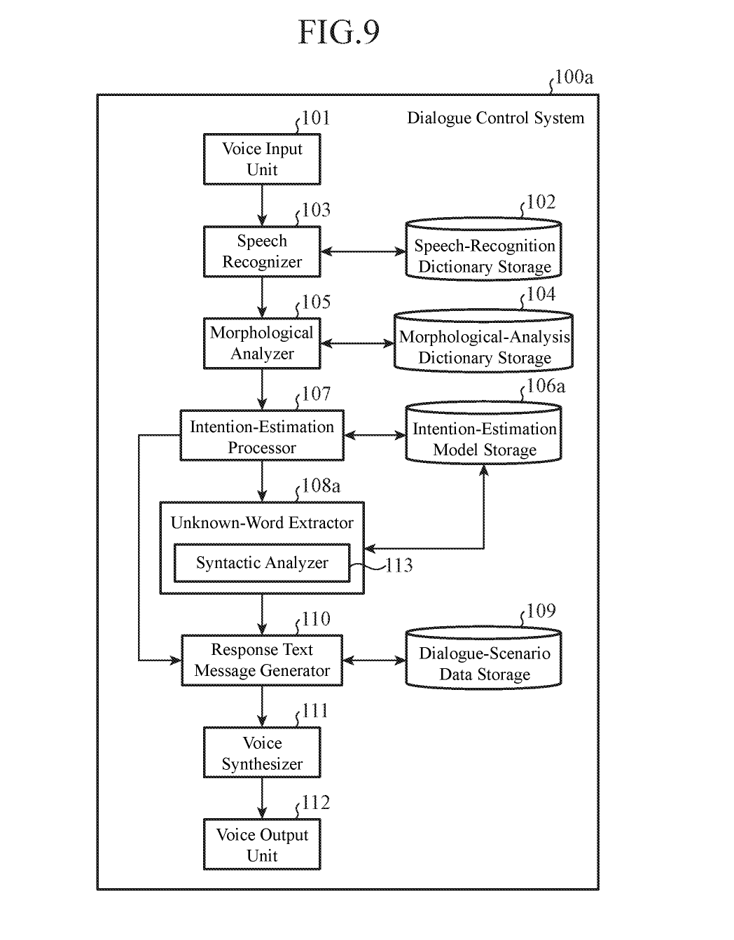

FIG. 9 is a block diagram showing a configuration of an dialogue control system 100a according to the second embodiment.

In the second embodiment, an unknown-word extractor 108a further includes a syntactic analyzer 113, and an intention-extraction model storage 106a is storing therein a frequently-appearing word list in addition to the intention estimation model. Note that, in the following, with respect to the parts same as or equivalent to the configuration elements of the dialogue control system 100 according to the first embodiment, the reference numerals same as those used in the first embodiment are given thereto, so that their description will be omitted or simplified.

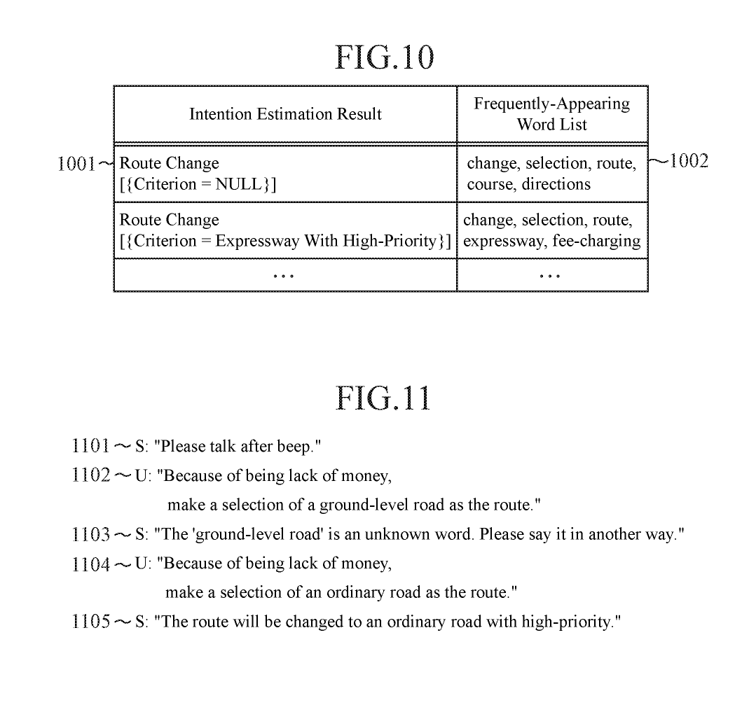

The syntactic analyzer 113 further analyzes syntactically the morphological analysis results obtained by the morphological analyzer 105. The unknown-word extractor 108a performs extraction of unknown word using dependency information indicated by the syntactic analysis result obtained by the syntactic analyzer 113. An intention-estimation model storage 106a is a memory region where the frequently-appearing word list is stored in addition to the intention estimation model shown in the first embodiment. The frequently-appearing word list is that in which frequently appearing words that appear highly frequently with respect to a given intention estimation result are stored as a list as shown, for example, in FIG. 10, and a frequently-appearing word list 1002 of “change, selection, route, course, directions” is being associated with an intention estimation result 1001 of “Route Change [{Criterion=NULL}]”.

Next, operations of the dialogue control system 100a according to the second embodiment will be described.

FIG. 11 is a diagram showing an example of a dialogue with the dialogue control system 100a according to the second embodiment.

As similar to in FIG. 2 of the first embodiment, at beginning of each line, “U:” represents a user's speech, and “S:” represents a response from the dialogue control system 100a. A response 1101, a response 1103 and a response 1105 are each a response from the dialogue control system 100a, and a speech 1102 and a speech 1104 are each a user's speech, and there is thus shown that dialogue proceeds sequentially.

Descriptions will be made about processing operations in the dialogue control system 100a, for generating a response text message matched with the user's speech shown in FIG. 11, with reference to FIG. 10 and FIGS. 12 to 14.

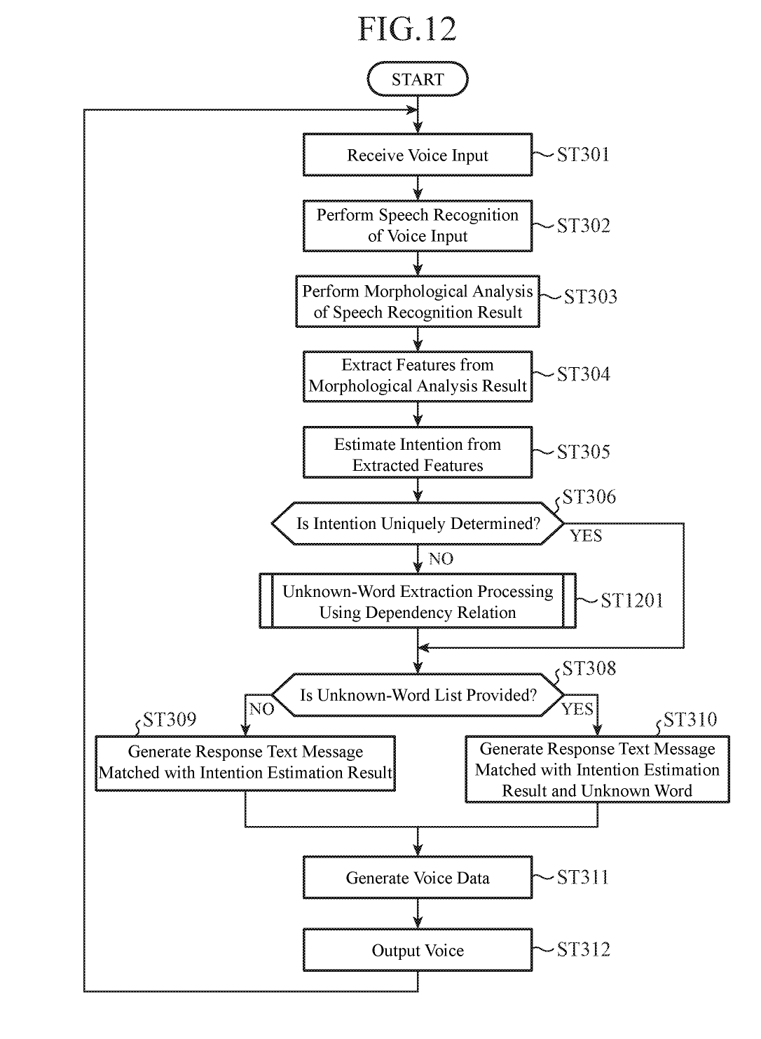

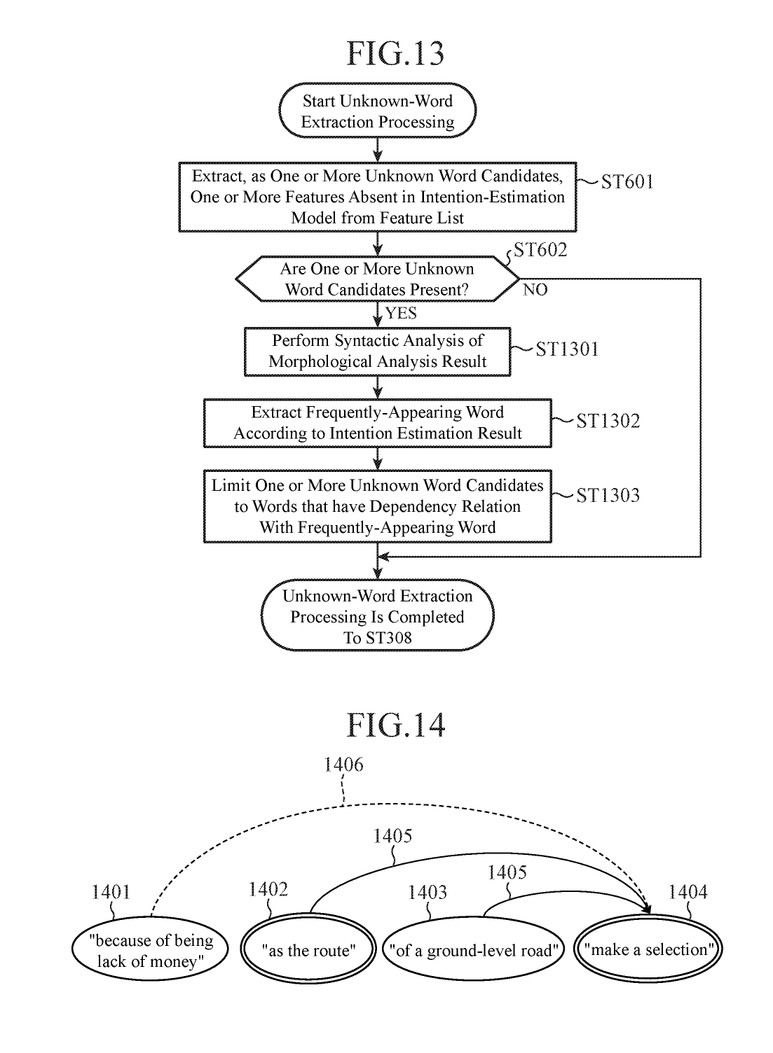

FIG. 12 is a flowchart showing operations of the dialogue control system 100a according to the second embodiment. FIG. 13 is a flowchart showing operations of the unknown-word extractor 108a in the dialogue control system 100a according to the second embodiment. In FIG. 12 and FIG. 13, with respect to the steps that are the same as those performed by the dialogue control system 100 according to the first embodiment, the same numerals as those used in FIG. 3 and FIG. 6 are given thereto, so that their descriptions will be omitted or simplified.

FIG. 14 is a diagram showing an example of the syntactic analysis result obtained by the syntactic analyzer 113 in the dialogue control system 100a according to the second embodiment. In the example in FIG. 14, it is shown that a lexical chunk 1401, a lexical chunk 1402 and a lexical chunk 1403 modify a lexical chunk 1404.

It is noted firstly that, as shown in the flowchart in FIG. 12, the basic operations of the dialogue control system 100a of the second embodiment are the same as those of the dialogue control system 100 of the first embodiment, but there is a difference only in that the unknown-word extractor 108a performs extraction of unknown word in Step ST1201 using the dependency information that is the analysis result obtained by the syntactic analyzer 113. Exactly, the processing of extraction of unknown word by the unknown-word extractor 108a is performed based on the flowchart in FIG. 13.

First, based on the example of dialogue between the dialogue control system 100a and the user shown in FIG. 11, the basic operations of the dialogue control system 100a will be described according to the flowchart in FIG. 12.

When the user presses the dialogue start button, the dialogue control system 100a outputs by voice the response 1101 of “Please talk after beep” and then outputs a beep sound. After they are outputted, the voice recognizer 103 becomes in a recognizable state and the procedure moves to the processing in Step ST301 in the flowchart in FIG. 12. Note that the beep sound after the voice outputting may be changed appropriately.

When the user would like to search for the route using an ordinary road as the search criterion, and speaks to make the speech 1102 of “Because of being lack of money, make a selection of a ground-level road as the route” [“Kin-ketu na node, ‘route’ wa shita-michi wo senntaku si te” in Japanese pronunciation], the voice input unit 101 receives it as a voice input in Step ST301. In Step ST302, the speech recognizer 103 performs speech recognition of the received voice input to convert it into a text. With respect to the speech recognition result of “Because of being lack of money, make a selection of a ground-level road as the route” [“Kin-ketsu na node, ‘route’ wa shita-michi wo sentaku si te”], the morphological analyzer 105 performs morphological analysis in Step ST303 so as to obtain “‘ lack of money’ [Kin-ketsu]/noun; [na]/auxiliary verb; [node]/postpositional particle; ‘route’/noun; [wa]/postpositional particle; ‘ground-level road’ [shita-michi]/noun; [wo]/postpositional particle; ‘selection’ [sentaku]/noun (to be connected to the verb ‘suru’ in Japanese pronunciation); ‘make’ [si]/verb; and [te]/postpositional particle”. In Step ST304, the intention-estimation processor 107 extracts from the morphological analysis results obtained in Step ST303, the features to be used in intention estimation processing of “‘lack of money’/noun”, “‘route’/noun”, “‘ground-level road’/noun” and “‘selection’/noun (to be connected to the verb ‘suru’ in Japanese pronunciation)”, to thereby generate a feature list consisting of these four features.

Furthermore, in Step ST305, the intention-estimation processor 107 performs intention estimation processing on the feature list generated in Step ST304. Here, if the features of “‘lack of money’/noun” and “‘ground-level road’/noun”, for example, are absent in the intention estimation model stored in the intention-estimation model storage 6, the intention estimation processing is executed based on the features of “‘route’/noun” and “‘selection’/noun (to be connected to the verb ‘suru’ in Japanese pronunciation)”, so that the intention-estimation result list shown in FIG. 5 is obtained like in the first embodiment. The intention estimation result of “Route Change [{Criterion=NULL}]” indicated with the ranking “1” is obtained with an intention estimation score of 0.583, and the intention estimation result of “Route Change [{Criterion=Ordinary Road With High-Priority}]” indicated with the ranking “2” is obtained with an intention estimation score of 0.177.

When the intention-estimation result list is obtained, the procedure moves to the processing in Step ST306.

As described above, because the intention-estimation result list in FIG. 5, that is the same as in the first embodiment, is obtained, the result of judgement in Step ST306 is provided as “No” to be the same as in the first embodiment, so that it is judged that an intention of the user fails to be uniquely determined, and the procedure moves to the processing in Step ST1201. On this occasion, the intention-estimation processor 107 outputs the intention-estimation result list and the feature list to the unknown-word extractor 108a.

In the processing in Step ST1201, based on the feature list provided from the intention-estimation processor 107, the unknown-word extractor 108a performs unknown-word extraction processing, utilizing the dependency information obtained by the syntactic analyzer 113. The unknown-word extraction processing utilizing dependency information in Step ST1201 will be described in detail with reference to the flowchart in FIG. 13.

The unknown-word extractor 108a extracts from the provided feature list, any feature that is not included in the intention estimation model stored in the intention-estimation model storage 106, as an unknown-word candidate, and adds it to an unknown-word candidate list (Step ST601).

In the case of the feature list generated in Step ST304, from among the four features of “‘lack of money’/noun”, “‘route’/noun”; “‘ground-level road’/noun” and “‘selection’/noun (to be connected to the verb ‘suru’ in Japanese pronunciation)”, the features of “‘lack of money’/noun” and

“‘ground-level road’/noun” are extracted as unknown-word candidates and added to the unknown-word candidate list.

Then, the unknown-word extractor 108a judges whether or not one or more unknown-word candidates have been extracted in Step ST601 (Step ST602). When no unknown-word candidate has been extracted (Step ST602; NO), the unknown-word extraction processing is terminated and the procedure moves to the processing in Step ST308.

In contrast, when one or more unknown-word candidates have been extracted (Step ST602; YES), the syntactic analyzer 113 divides the morphological analysis results into units of lexical chunks, and analyzes dependency relations with respect to the lexical chunks to thereby obtain the syntactic analysis result (Step ST1301).

With respect to the above-described morphological analysis results: “‘lack of money’ [Kin-ketsu]/noun; [na]/auxiliary verb; [node]/postpositional particle; ‘route’/noun; [wa]/postpositional particle; ‘ground-level road’ [shita-michi]/noun; [wo]/postpositional particle; ‘selection’ [sentaku]/noun (to be connected to the verb ‘suru’ in Japanese pronunciation); ‘make’ [si]/verb; and [te]/postpositional particle”, they are firstly divided in Step ST1301 into units of the lexical chunks: “‘ Because of being lack of money’ [Kin-ketsu/na/node]: verbal phrase”, “‘as the route’ [route/wa]: noun phrase”, “‘of ground-level road’ [shita-michi/wo]: noun phrase” and “‘make selection’ [sentaku/si/te]:verbal phrase”. Furthermore, the dependency relations among the respective lexical chunks are analyzed to thereby obtain the syntactic analysis result shown in FIG. 14.

In the example of the syntactic analysis result shown in FIG. 14, the lexical chunk 1401 modifies the lexical chunk 1404, the lexical chunk 1402 modifies the lexical chunk 1404, and the lexical chunk 1403 modifies the lexical chunk 1404. Here, the types of dependencies are categorized into a first dependency type and a second dependency type. The first dependency type is such a type in which a noun or an adverb is used to modify a verb or an adjective, and corresponds to a dependency type 1405 in the example in FIG. 14, in which “‘as the route’: noun phrase” and “‘of ground-level road’: noun phrase” modify “‘make selection’: verbal phrase”. On the other hand, the second dependency type is such a type in which a verb, an adjective or an auxiliary verb is used to modify a verb, an adjective or an auxiliary verb, and corresponds to a dependency type 1406 in which “‘because of being lack of money’: verbal phrase” modifies “‘make selection’: verbal phrase”.

After completion of the processing of syntactic analysis in ST1301, the unknown-word extractor 108a extracts frequently-appearing words, according to the intention estimation result (Step ST1302). In the case, for example, where the intention estimation result 1001 of “Route Change [{Criterion=NULL}]” shown in FIG. 10 is obtained in Step ST1302, the frequently-appearing word list 1002 of “change, selection, route, course, directions” is chosen.

Then, the unknown-word extractor 108a refers to the syntactic analysis result obtained in Step ST1301, to thereby extract therefrom one or more lexical chunks including a word that is among the unknown-word candidates extracted in Step ST601 and that establishes a dependency relation of the first dependency type with the frequently-appearing word extracted in Step ST1302, and adds the word included in the extracted one or more lexical chunks to the unknown-word list (Step ST1303).

As shown in FIG. 14, there are two lexical chunks comprised of the lexical chunk 1402 of “as the route” and the lexical chunk of 1404 of “make selection”, each lexical chunk including the frequently-appearing word existing in the chosen frequently-appearing word list 1002. In the lexical chunks including the respective unknown-word candidates of “lack of money” and “ground-level road” that modify the lexical chunk 1404, the lexical chunk that modifies the lexical chunk 1404 according to the first dependency type is the lexical chunk 1403 of “of ground-level road” including the unknown-word candidate of “ground-level road”, only. Accordingly, in an unknown-word list, “ground-level road” is included only.

The unknown-word extractor 108a outputs the intention estimation result and, if an unknown-word list is present, the unknown-word list, to the response text message generator 110.

Returning to the flowchart in FIG. 12, description will be continued about the operations.

The response text message generator 110 judges whether or not the unknown-word list has been provided by the unknown-word extractor 108a (Step ST308), and thereafter, the same processing as in Step ST309 to Step ST312 shown in the first embodiment is performed. According to the examples shown in FIG. 10 and FIG. 14, the response 1103 of “The word ‘Ground-level road’ is an unknown word. Please say it in another way” shown in FIG. 11 is outputted by voice. Thereafter, the procedure in the flowchart returns to the processing in Step ST301, to wait a voice input to be made by the user.

Because of the response 1103 outputted by voice, the user can be aware that he/she just has to change “ground-level road” by saying it in another way, so that the user can talk again in a manner, for example, like “Because of being lack of money, perform setting of an ordinary road as the route” as shown at the speech 1104 in FIG. 11. Accordingly, “Route Change [{Criterion=Ordinary Road With High-Priority}]” is obtained as the intention estimation result for the speech 1104, so that the system outputs by voice the response 1105 of “I will change for an ordinary road with high-priority as the route”. In this manner, it is possible to execute the command according to the original intention of the user of “I want to search for an ordinary road as the route”, through a smooth dialogue with the dialogue control system 100a.

As described above, the configuration according to the second embodiment includes: the syntactic analyzer 113 that performs syntactic analysis of the morphological analysis result obtained by the morphological analyzer 105; and the unknown-word extractor 108a that extracts an unknown word on the basis of the dependency relations among the obtained lexical chunks. Thus, it is possible to extract the unknown word in a manner limited to a specific content word from the result of the syntactic analysis of the user's speech, and, then, to include that word in the response text message provided by the dialogue control system 100a. Among the words that fail to be recognized by the dialogue control system 100a, an important word can be presented to the user. This makes it possible for the user to recognize the word to be spoken again correctly, so that the dialogue can proceed smoothly.

### Third Embodiment

In a third embodiment, descriptions will be made about a configuration for performing extraction of known word using the morphological analysis results, that is processing opposite to the unknown-word extraction processing in the first embodiment and the second embodiment described above.

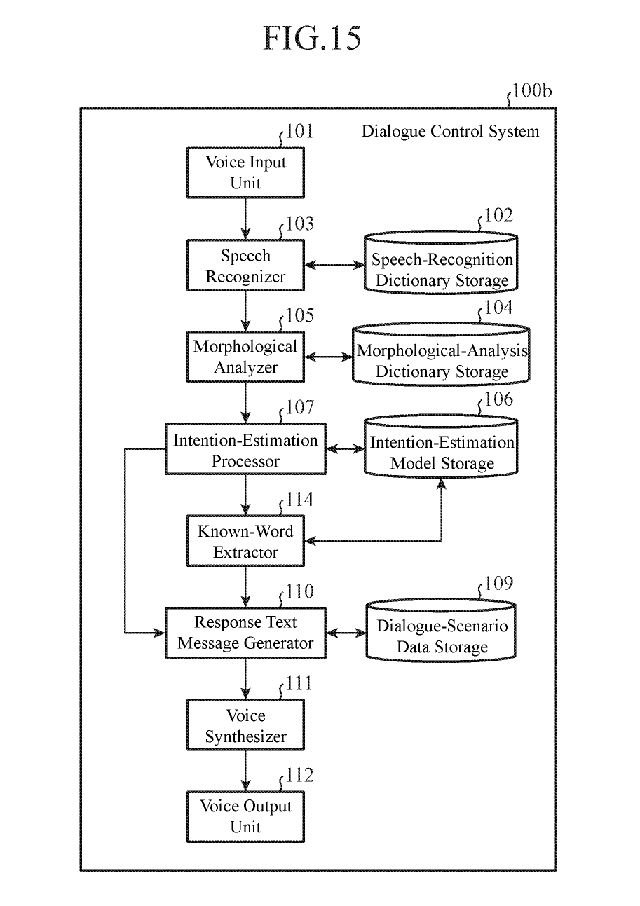

FIG. 15 is a block diagram showing a configuration of an dialogue control system 100b according to the third embodiment.

In the third embodiment, the configuration is resulted from the dialogue control system 100 in the first embodiment shown in FIG. 1, by providing a known-word extractor 114 in place of the unknown-word extractor 108. Note that, in the following, with respect to the parts same as or equivalent to the configuration elements of the dialogue control system 100 according to the first embodiment, the reference numerals same as those used in the first embodiment are given thereto, so that their description will be omitted or simplified.

The known-word extractor 114 extracts from among the features extracted by the morphological analyzer 105, any feature that is not stored in intention estimation model of the intention-estimation model storage 106, as an unknown-word candidate, and extracts therefrom, any feature that is other than the extracted unknown-word candidate, as a known word.

Next, operations of the dialogue control system 100b according to the third embodiment will be described.

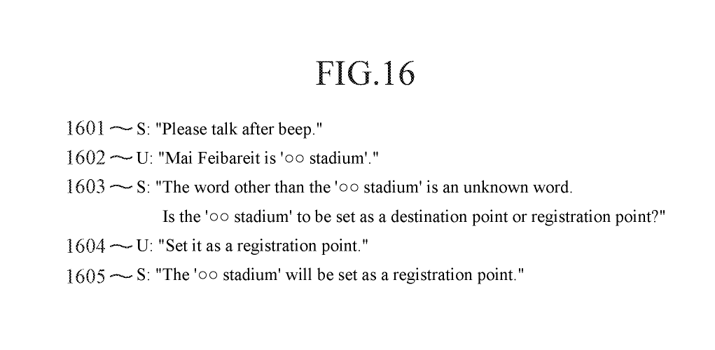

FIG. 16 is a diagram showing an example of dialogue between the dialogue control system 100b according to the third embodiment and the user.

As similar to in FIG. 2 of the first embodiment, at beginning of each line, “U:” represents a user's speech, and “S:” represents a speech/response from the dialogue control system 100b. A response 1601, a response 1603 and a response 1605 are each a response from the dialogue control system 100b, and a speech 1602 and a speech 1604 are each a user's speech, and there is thus shown that dialogue proceeds sequentially.

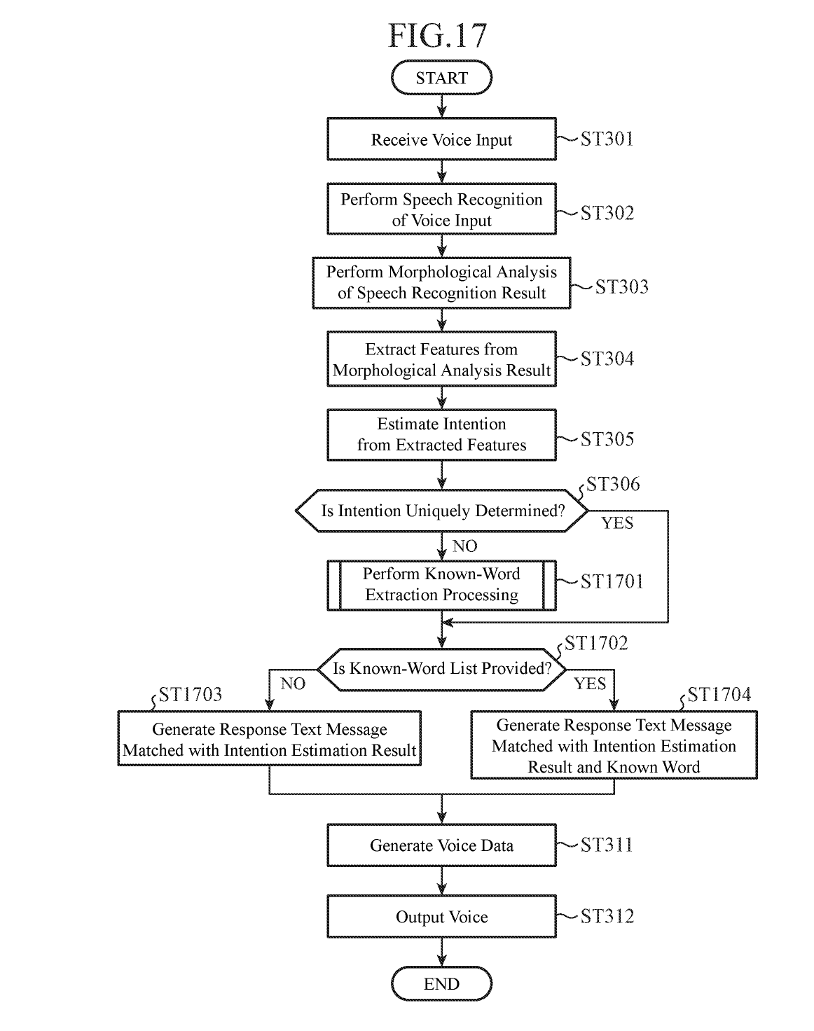

Based on the dialogue example in FIG. 16, descriptions will be made about processing operations in the dialogue control system 100b, for generating a response text message, with reference to FIGS. 17 to 20.

FIG. 17 is a flowchart showing operations of the dialogue control system 100b according to the third embodiment.

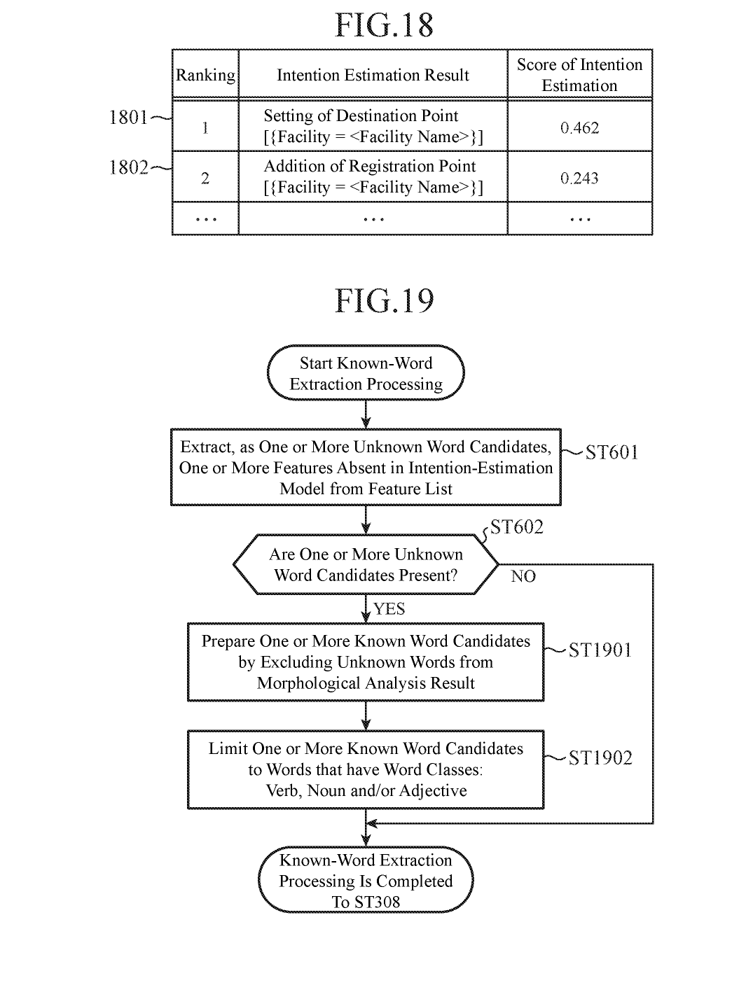

FIG. 18 is a diagram showing an example of intention estimation results obtained by the intension estimation processor 107 in the dialogue control system 100b according to the third embodiment. As an intention estimation result 1801, an intention estimation result having the first ranked intention estimation score is shown with that intention estimation score, and as an intention estimation result 1802, an intention estimation result having the second ranked intention estimation score is shown with that intention estimation score.

FIG. 19 is a flowchart showing operations of the known-word extraction processor 114 in the dialogue control system 100b according to the third embodiment. In FIG. 17 and FIG. 19, with respect to the steps that are the same as those performed by the dialogue control system according to the first embodiment, the same numerals as those used in FIG. 3 and FIG. 6 are given thereto, so that their descriptions will be omitted or simplified.

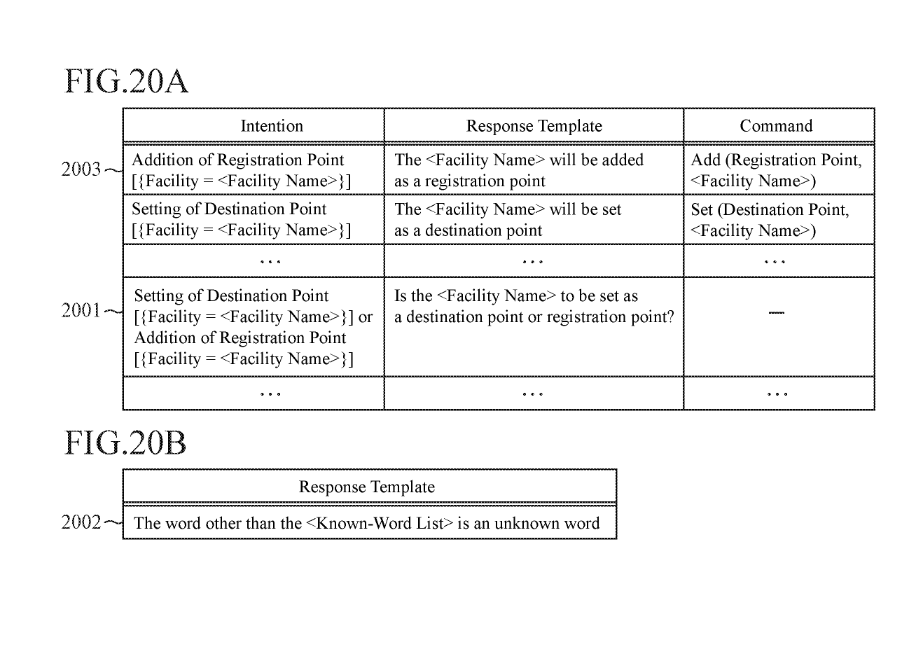

FIG. 20 is a diagram showing an example of dialogue-scenario data stored in the dialogue-scenario data storage 109 in the dialogue control system 100b according to the third embodiment. In the dialogue-scenario data for intention in FIG. 20A, responses to be provided by the dialogue control system 100b for the respective intention estimation results are included, and commands to be executed by the dialogue control system 100b for a device (not shown) controlled by that system are included. Further, in the dialogue-scenario data for known word in FIG. 20B, a response to be provided by the dialogue control system 100b for the known word is included.

As shown in the flowchart in FIG. 17, the basic operations of the dialogue control system 100b of the third embodiment are the same as those of the dialogue control system 100 of the first embodiment, but there is a difference only in that the known-word extractor 114 performs extraction of known word in Step ST1701. Exactly, the processing of extraction of known word by the known-word extractor 114 is performed based on the flowchart in FIG. 19.

First, based on the example of dialogue with the dialogue control system 100b shown in FIG. 16, the basic operations of the dialogue control system 100b will be described according to the flowchart in FIG. 17.

When the user presses the dialogue start button, the dialogue control system 100b outputs by voice the response 1601 of “Please talk after beep” and then outputs a beep sound. After they are outputted, the voice recognizer 103 becomes in a recognizable state and the procedure moves to the processing in Step ST301 in the flowchart in FIG. 17. Note that the beep sound after the voice outputting may be changed appropriately.

On this occasion, when the user speaks to make the speech 1602 of “Mai Feibareit is ‘◯◯ stadium’” [“◯◯ stadium′ wo ‘Mai Feibareit’”, in Japanese pronunciation], the voice input unit 101 receives it as a voice input in Step ST301. In Step ST302, the speech recognizer 103 performs speech recognition of the received voice input to convert it into a text. In Step ST303, the morphological analyzer 105 performs morphological analysis of the speech recognition result of “Mai Feibareit is ‘◯◯ stadium’ [‘◯◯ stadium’ wo ‘Mai Feibareit’]” so as to obtain “‘◯◯ stadium’/noun (facility name); ‘wo’/postpositional particle; and ‘Mai Feibareit’/noun”. In Step ST304, the intention-estimation processor 107 extracts from the morphological analysis results obtained in Step ST303, the features of “#Facility Name (=‘◯◯ stadium’)” and “Mai Feibareit” to be used in intention estimation processing, and generates a feature list comprised of these two features. Here, “#Facility Name” is a special symbol indicative of a name of facility.

Furthermore, in Step ST305, the intention-estimation processor 107 performs intention estimation processing on the feature list generated in Step ST304. At this time, if the feature “Mai Feibareit”, for example, is absent in the intention estimation model stored in the intention-estimation model storage 106, the intention estimation processing is executed based on the feature of “#Facility Name”, so that an intention-estimation result list shown in FIG. 18 is obtained. The intention estimation result 1801 of “Destination Point Setting [{Facility=<Facility Name>}]” indicated with the ranking “1” is obtained with an intention estimation score of 0.462, and the intention estimation result 1802 of “Registration Point Addition [{Facility=<Facility Name>}]” indicated with the ranking “2” is obtained with an intention estimation score of 0.243. Note that, in FIG. 18, though omitted from illustration, intention estimation results and their intention estimation scores with the rankings subsequent to the ranking “1” and the ranking “2” are set as well.

When the intention-estimation result list is obtained, the procedure moves to the processing in Step ST306.

The intention-estimation processor 107 judges based on the intention-estimation result list obtained in Step ST305, whether or not an intention of the user can be uniquely determined (Step ST306). The judgement processing in Step ST306 is performed based, for example, on the two criteria (a), (b) shown in the first embodiment previously described. When the criterion (a) and the criterion (b) are both satisfied, namely, an intention of the user can be uniquely determined (Step ST306; YES), the procedure moves to the processing in Step ST308. On this occasion, the intention-estimation processor 107 outputs the intention-estimation result list to the response text message generator 110.

In contrast, when at least one of the criterion (a) and the criterion (b) is not satisfied, namely, when no intention of the user can be uniquely determined (Step ST306; NO), the procedure moves to the processing in Step ST307. On this occasion, the intention-estimation processor 107 outputs the intention-estimation result list and the feature list to the known-word extractor 114.

In the case of the intention estimation result with the ranking “1” shown in FIG. 18, the intention estimation score is “0.462” and thus does not satisfy the criterion (a). Accordingly, it is judged that no intention of the user can be determined, so that the procedure moves to the processing in Step ST1701.

In the processing in Step ST1701, the known-word extractor 114 performs extraction of known word based on the feature list provided from the intention-estimation processor 107. The known-word extraction processing in Step ST1701 will be described in detail with reference to the flowchart in FIG. 19.

The known-word extractor 114 extracts from the provided feature list, any feature that is not included in the intention estimation model stored in the intention-estimation model storage 106, as an unknown-word candidate, and adds it to an unknown-word candidate list (Step ST601).

In the case of the feature list generated in Step ST304, the feature “Mai Feibareit” is extracted as an unknown word candidate and added to the unknown-word candidate list.

Then, the known-word extractor 114 judges whether or not one or more unknown-word candidates have been extracted in Step ST601 (Step ST602). When no unknown-word candidate has been extracted (Step ST602; NO), the unknown-word extraction processing is terminated and the procedure moves to the processing in Step ST308.

In contrast, when one or more unknown-word candidates have been extracted (Step ST602; YES), the known-word extractor 114 collects any of the features other than the unknown-word candidates included in the unknown-word candidate list, as a known-word candidate list (Step ST1901).

In the case of the feature list generated in Step ST304, “#Facility Name” corresponds to the known-word candidate list. Then, the known-word extractor deletes from those in the known-word candidate list collected in Step ST1901, any known-word candidate whose lexical category is other than verb, noun and adjective, to thereby modify the list into a known-word list (Step ST1902).

In the case of the feature list generated in Step ST304, “#Facility Name” corresponds to the known-word candidate list and, conclusively, only “◯◯ stadium” is included in the known-word list. The known-word extractor 114 outputs the intention-estimation results and, if a known-word list is present, the known-word list, to the response text message generator 110.

Returning to the flowchart in FIG. 17, description will be continued about the operations.

The response text message generator 110 judges whether or not the known-word list has been provided by the known-word extractor 114 (Step ST1702). When no known-word list has been provided (Step ST1702; NO), the response text message generator 110 generates a response text message using the dialogue-scenario data stored in the dialogue-scenario data storage 109 by reading out therefrom a response template matched with the intention estimation result (Step ST1703). Further, when a corresponding command is set in the dialogue-scenario data, the command will be executed according to Step ST1703.

When the known-word list has been provided (Step ST1702; YES), the response text message generator 110 generates a response text message using the dialogue-scenario data stored in the dialogue-scenario data storage 109 by reading out therefrom a response template matched with the intention estimation result and a response template matched with the known word listed in the known-word list (Step ST1704). At the generation of the response text message, a response text message matched with the known-word list is inserted before a response text message matched with the intention estimation result. Further, when a corresponding command is set in the dialogue-scenario data, the command will be executed according to Step ST1704.

In the example of the intention estimation results shown in FIG. 18, two of them, namely, the first ranked intention estimation result of “Destination Point Setting [{Facility=<Facility Name>}]” and the second ranked intention estimation result of “Registration Point Addition [{Facility=<Facility Name>}]” are shown to be ambiguous, so that a response template 2001 matched with them is read out and a response text message of “Is ‘◯◯ stadium’ to be set as destination point or registration point?” is generated.

Then, when the known-word list has been provided, the response text message generator 110 replaces <Known Word> in a template 2002 in the dialogue-scenario data for known word shown in FIG. 20B, with an actual value in the known-word list, to thereby generate a response text message. For example, when the provided known word is “◯◯ stadium”, the generated response text message is “The word other than ‘◯◯ stadium’ is unknown word”. Lastly, the response text message matched with the known-word list is inserted before the response text message matched with the intention estimation results, so that a response text message of “The word other than ‘◯◯ stadium’ is unknown word. Is ‘◯◯ stadium’ to be set as destination point or registration point?” is generated.

The voice synthesizer 111 generates voice data from the response text message generated in Step ST1703 or Step ST1704, and outputs the data to the voice output unit 112 (Step ST311). The voice output unit 112 outputs as voice, the voice data provided in Step ST311 (Step ST312). Consequently, processing of generating the response text message with respect to one user's speech is completed. According to the examples shown in FIG. 18 and FIG. 20, “The word other than ‘◯◯ stadium’ is unknown word. Is ‘◯◯ stadium’ to be set as destination point or registration point?”, that is the response 1603 shown in FIG. 16, is outputted by voice. Thereafter, the procedure in the flowchart returns to the processing in Step ST301, to wait a voice input to be made by the user.

Because the response 1603 is outputted by voice, the user understands that the word other than “◯◯ stadium” has not been recognized, and thus can be aware that “Mai Feibareit” has not been recognized and so he/she just has to speak it using a different expression. For example, the user can talk again in a manner represented by the speech 1604 of “Add it as registration point” in FIG. 16, and thus can perform dialogue with the dialogue control system 100b using the word usable therefor.

With respect to the speech 1604, the dialogue control system 100b again executes speech recognition processing shown in the flowcharts in FIG. 17 and FIG. 19. As a result, an intention estimation result of “Registration Point Addition [{Criterion=<Facility Name>}]” is obtained in Step ST305.

Furthermore, in Step ST1703, a template 2003 in the dialogue-scenario data for intention in FIG. 20A is read out as a response template matched with “Registration Point Addition [{Criterion=<Facility Name>}]” and a response text message of “Will add ‘◯◯ stadium’ as registration point” is generated, so that a command of “Add (Registration Point, <Facility Name>)”, that is given for adding the facility name as a registration point, will be executed. Then, in Step ST311, voice data is generated from the response text message, and in Step ST312, the voice data is outputted by voice. In this manner, it is possible to execute the command according to the user's intention, through a smooth dialogue with the dialogue control system 100b.

As described above, the configuration according to the third embodiment includes: the morphological analyzer 105 that divides the speech recognition result into morphemes; the intention-estimation processor 107 that estimates an intention of the user from the morphological analysis results; the known-word extractor 114 that, when an intention of the user fails to be uniquely determined, extracts from the morphological analysis results, a feature that is other than the unknown word, as a known word; and the response text message generator 110 that, when the known word is extracted, generates a response text message that includes the known word, namely, a response text message that includes another word than any of the words provided as the unknown word. Thus, it is possible to present a word from which any intention can be estimated by the dialogue control system 100b, to thereby cause the user to recognize a word to be changed in expression, so that the dialogue can proceed smoothly.

Although the description in above-described Embodiments 1 to 3 has been made about the case, as an example, where Japanese language is phonetically recognized, the dialogue control systems 100, 100a, 100b can be applied to a variety of languages in English, German, Chinese and the like, by changing the extraction method of feature related to the intention estimation, performed by the intention estimation processor 107, for each of the respective languages.

Further, when the dialogue control systems 100, 100a, 100b shown in above-described first to third embodiments are to be applied to the language whose word is partitioned by a specific symbol (for example, a space), and when its linguistic structure is difficult to be analyzed, it is also allowable to provide, in place of the morphological analyzer 105, a configuration for performing extraction processing to extract <Facility Name>, <Residence> or the like, from an input natural language text, using a pattern matching method, for example; and to configure the intention-estimation processor 107 so as to execute intention estimation processing on the extracted <Facility Name>, <Residence> or the like.

Further, in the first to third embodiments described above, the descriptions has been made using the exemplary case where the processing of morphological analysis is performed on the text input obtained through the speech recognition when a voice input is entered. Alternatively, it is allowable not to use the speech recognition result as an input, but to configure so that the processing of morphological analysis is executed on a text input provided by using an input means, for example, a keyboard or the like. With this configuration, with respect to a text input other than a voice input, a similar effect to the above can also be achieved.

Further, in the first to third embodiments described above, such a configuration has been shown in which the morphological analyzer 105 performs processing of morphological analysis of the text provided as the speech recognition result, and then intention estimation is performed. Alternatively, in the case where a result obtained by the voice recognition engine includes itself a morphological analysis results, it is allowable to configure so that intention estimation can be executed directly using information indicating that result.

Further, in the first to third embodiments described above, although the intention estimation method has been described using an example in which a learning model using a maximum entropy method is assumed to be applied, the intention estimation method is not limited thereto.

### INDUSTRIAL APPLICABILITY

The dialogue control system according to the invention is capable of providing feedback to the user on information indicating which word among the words spoken by the user cannot be used, and therefore is suitable for use in improving smoothness of the dialogue with a car-navigation, a mobile phone, a portable terminal, an information device or the like in which a speech recognition system or the like is installed.

### REFERENCE SIGNS LIST

100, 100a, 100b: dialogue control system, 101: voice input unit, 102: speech-recognition dictionary storage, 103: speech recognizer, 104: morphological-analysis dictionary storage, 105: morphological analyzer, 106, 106a: intention-estimation model storage, 107: intention-estimation processor, 108, 108a: unknown-word extractor, 109: dialogue-scenario data storage, 110: response text message generator, 111: voice synthesizer, 112: voice output unit, 113: syntactic analyzer, 114: known-word extractor.

1. A dialogue control system comprising:
a text analyzer to analyze a text provided as an input in a form of natural language by a user;
an intention-estimation processor to refer to an intention estimation model in which words and corresponding user's intentions to be estimated from the words are stored, to thereby estimate an intention of the user based on text analysis results obtained by the text analyzer;
an unknown-word extractor to extract, as an unknown word, a word that is not stored in the intention estimation model from among the text analysis results when the intention of the user fails to be uniquely determined by the intention estimation processor; and
a response text message generator to generate a response text message that includes the unknown word extracted by the unknown-word extractor.

2. The dialogue control system of claim 1, wherein:
the text analyzer is configured to perform morphological analysis to divide the text provided as an input, into separate words; and
the unknown-word extractor is configured to extract, as the unknown word, a content word that is not stored in the intention estimation model from among the separate words obtained by the text analyzer.

3. The dialogue control system of claim 1, wherein the response text message generator is configured to generate the response text message indicating that the intention of the user fails to be uniquely determined due to the unknown word extracted by the unknown-word extractor.

4. The dialogue control system of claim 2, wherein the unknown-word extractor is configured to extract, as the unknown word, only the content word that belongs to a specific lexical category.

5. The dialogue control system of claim 2, wherein the unknown-word extractor is configured to divide results of the morphological analysis obtained by the text analyzer into lexical chunks, perform syntactic analysis for analyzing dependency relations among the lexical chunks, and refer to a result of the syntactic analysis to thereby extract, as the unknown word, the content word that has a dependency relation with a word being defined as a frequently-appearing word corresponding to the intention of the user estimated by the intention-estimation processor.

6. A dialogue control system comprising:
a text analyzer to analyze a text provided as an input in a form of natural language by a user;
an intention-estimation processor to refer to an intention estimation model in which words and corresponding user's intentions to be estimated from the words are stored, to thereby estimate an intention of the user based on text analysis results obtained by the text analyzer;
a known-word extractor to extract, as one or more unknown words, words that are not stored in the intention estimation model from among the text analysis results when the intention of the user fails to be uniquely determined by the intention estimation processor, and to extract, as a known word, a word other than the one or more unknown words from among the text analysis results when the one or more unknown words have been extracted; and
a response text message generator to generate a response text message that includes the known word extracted by the known-word extractor.

7. The dialogue control system of claim 6, wherein:
the text analyzer is configured to perform morphological analysis to divide the text provided as an input, into separate words; and
the known-word extractor is configured to extract, as the known word, a content word other than the one or more unknown words from among the separate words obtained by the text analyzer.

8. The dialogue control system of claim 6, wherein the response text message generator is configured to generate the response text message indicating that the intention of the user fails to be uniquely determined due to a word other than the known word that is extracted by the known-word extractor.

9. The dialogue control system of claim 7, wherein the known-word extractor is configured to extract, as the known word, only the content word belonging to a specific lexical category.

10. A dialogue control method comprising:
analyzing a text provided as an input in a form of natural language by a user;
referring to an intention estimation model in which words and corresponding user's intentions to be estimated from the words are stored, to thereby estimate an intention of the user based on results of the analysis of the text;
extracting, as an unknown word, a word that is not stored in the intention estimation model from among the results of the analysis of the text when the intention of the user fails to be uniquely determined; and
generating a response text message that includes the unknown word obtained by the extraction.
